(19) United States
(12) Patent Application Publication
(10) Pub. No.: US 2024/0359847 A1
(43) Pub. Date: Oct. 31, 2024

(54) FIXTURE FOR UNPACKING A CARTON

(71) Applicant: ABB SCHWEIZ AG, Baden (CH)

(72) Inventors: Yang Li, Shanghai (CN); Jie Wang, Shanghai (CN); Jiaxin Yan, Shanghai (CN); Yin Tian, Shanghai (CN)

(21) Appl. No.: 18/766,872

(22) Filed: Jul. 9, 2024

Related U.S. Application Data
(63) Continuation of application No. PCT/CN2022/076370, filed on Feb. 15, 2022.

(51) Int. Cl. B65B 43/30

(52) U.S. Cl. CPC B65B 43/305

(57) ABSTRACT

A fixture for unpacking a carton, wherein the fixture includes a fixed portion and a rotating portion. The fixed portion includes a first frame, a first plurality of suction components, and a first driving component arranged on the first frame. The a rotating portion includes a second frame connected to the first frame and capable of rotating or being fixed relative to the first frame under the driving of the first driving component, a third frame arranged on the second frame, a second plurality of suction components arranged on the third frame, and a second driving component connected to the second frame and the third frame.

### FIELD

Embodiments of the present disclosure generally relate to the field of fixture for unpacking a carton, and more particularly, to a fixture for unpacking and sheathing large cartons with an industrial robot.

### BACKGROUND

At present, packing machines are widely used to pack cartons to industrial products. However, there is no packing machine for the packing of large household appliances such as refrigerators and washing machines. As a result, manual packing is generally used in packing these products. However, the labor cost of the enterprise is high, and the production efficiency is very low.

### SUMMARY

In view of the foregoing problems, various example embodiments of the present disclosure provide a fixture capable of unpacking large cartons, thereby increasing the production efficiency and reduce the packing cost.

In a first aspect of the present disclosure, example embodiments of the present disclosure provide a fixture for unpacking a carton. The fixture comprises a fixed portion comprising: a first frame; a first plurality of suction components arranged on the first frame and capable of sucking a first part of the carton; and a first driving component arranged on the first frame; and a rotating portion comprising: a second frame connected to the first frame and capable of rotating or being fixed relative to the first frame under the driving of the first driving component; a third frame arranged on the second frame and capable of moving relative to the second frame; a second plurality of suction components arranged on the third frame and capable of sucking a second part of the carton; and a second driving component connected to the second frame and the third frame and configured to fix the third frame to the second frame before the second plurality of suction components suck the carton, and not fix the third frame to the second frame after the second plurality of suction components suck the carton. With these embodiments, large cartons can be unpacked by the fixture instead of manual work, thereby increasing the production efficiency and reducing the packing cost.

In some embodiments, the third frame is arranged on the second frame through linear guide rails arranged on the second frame. With these embodiments, it can prevent the fixture from jamming during the unpacking, thereby increasing the success rate of unpacking.

In some embodiments, the first driving component comprises a servo motor, and the second frame comprises a sprocket connected to the servo motor through a chain. With these embodiments, the angle of unpacking can be precisely controlled.

In some embodiments, the fixed portion further comprises a flange made of square steel and configured to connect the fixed portion to an industrial robot. With these embodiments, the fixture can be installed to an industrial robot and can sheathe large cartons with the industrial robot.

In some embodiments, each of the fixed portion and the rotating portion further comprises a negative pressure gauge configured to check whether the carton is in place. With these embodiments, the position of the carton can be detected, thereby increasing the success rate of unpacking.

In some embodiments, each of the fixed portion and the rotating portion further comprises a photoelectric alarm configured to prompt abnormal taking and placing of the carton. With these embodiments, the position of the carton can be adjusted in time.

In some embodiments, each of the fixed portion and the rotating portion further comprises sensors configured to detect abnormal carton adsorption. With these embodiments, the abnormal separation between the carton and the suction components can be prevented during the unpacking.

In some embodiments, the second driving component comprises a cylinder. With these embodiments, the second driving component can be achieved in a cost effective manner.

In some embodiments, the first frame, the second frame and the third frame are made of aluminum profile. With these embodiments, the weight of the fixture can be reduced.

In some embodiments, the first plurality of suction components and the second plurality of suction components comprise suction cups connected to a vacuum generator arranged on the first frame. With these embodiments, the suction components can be achieved in a cost effective manner.

It is to be understood that the Summary section is not intended to identify key or essential features of embodiments of the present disclosure, nor is it intended to be used to limit the scope of the present disclosure. Other features of the present disclosure will become easily comprehensible through the following description.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in examples and in a non-limiting manner, wherein:

FIG. 1 is a schematic view illustrating a fixture in accordance with an embodiment of the present disclosure;

FIG. 2 is another schematic view illustrating a fixture in accordance with an embodiment of the present disclosure;

FIG. 3 is a schematic view illustrating a fixture in a first position in accordance with an embodiment of the present disclosure;

FIG. 4 is a schematic view illustrating a fixture in a second position in accordance with an embodiment of the present disclosure; and

FIG. 5 is a schematic view illustrating a fixture in a third position in accordance with an embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art to better understand and thereby implement the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

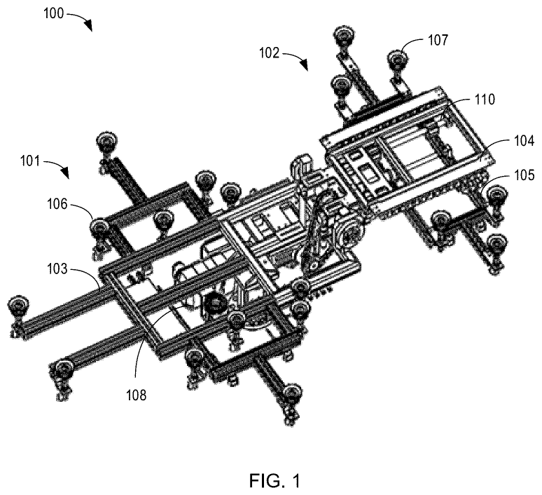

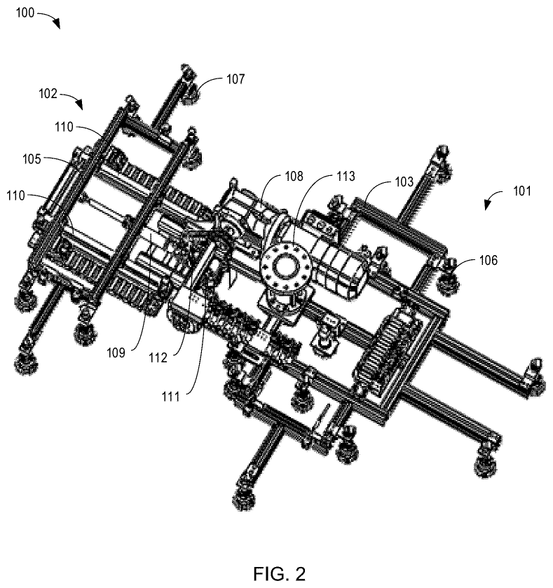

Hereinafter, the structure of a fixture in accordance with an embodiment of the present disclosure will be described in detail with reference to FIGS. 1-2. Refer to FIG. 1 first. FIG. 1 is a schematic view illustrating a fixture in accordance with an embodiment of the present disclosure.

As shown in FIG. 1, the fixture 100 comprises a fixed portion 101 and a rotating portion 102. The fixed portion 101 comprises a first frame 103, a first plurality of suction components 106 and a first driving component 108. The first plurality of suction components 106 are arranged on the first frame 103, and are capable of sucking a first part of the carton, for example, a first side of the carton. The first driving component 108 is also arranged on the first frame 103, and is used to drive the rotating portion 102.

The rotating portion 102 comprises a second frame 104, a third frame 105, a second plurality of suction components 107, and a second driving component 109. The second frame 104 is connected to the first frame 103 and capable of rotating or being fixed relative to the first frame 103 under the driving of the first driving component 108. The third frame 105 is arranged on the second frame 104 and capable of moving relative to the second frame 104. The second plurality of suction components 107 are arranged on the third frame 105 and capable of sucking a second part of the carton, for example, a second side of the carton. The second driving component 109 is connected to the second frame 104 and the third frame 105 and configured to fix the third frame 105 to the second frame 104 before the second plurality of suction components 107 suck the carton, and not fix the third frame 105 to the second frame 104 after the second plurality of suction components 107 suck the carton.

FIG. 2 is another schematic view illustrating a fixture in accordance with an embodiment of the present disclosure. In the embodiment as shown in FIG. 2, the third frame 105 is arranged on the second frame 104 through linear guide rails 110 arranged on the second frame 104. In other embodiments, the third frame 105 can be arranged on the second frame 104 through other structure. The scope of the present disclosure is not intended to be limited in this respect.

In the embodiment as shown in FIG. 2, the first driving component 108 is a servo motor, and the second frame 104 comprises a sprocket 111 connected to the servo motor through a chain 112. In other embodiments, the first driving component 108 can be other driving device, and the second frame 104 can be driven by the first driving component 108 through other structure. The scope of the present disclosure is not intended to be limited in this respect.

In the embodiment as shown in FIG. 2, the fixed portion 101 further comprises a flange 113 and configured to connect the fixed portion 101 to an industrial robot. The fixture 100 can rotate with the carton by the industrial robot. Thereby the carton can be sheathed to the products.

In some embodiment, the flange 113 is made of square steel to increase the strength. In other embodiments, the flange 113 can be made of other material. The scope of the present disclosure is not intended to be limited in this respect.

In some embodiment, positions of the first plurality of suction components 106 and the second plurality of suction components 107 can be arranged to fit cartons of different sizes.

In some embodiment, each of the fixed portion 101 and the rotating portion 102 further comprises a negative pressure gauge configured to check whether the carton is in place. In other embodiments, other device can be used to check whether the carton is in place. The scope of the present disclosure is not intended to be limited in this respect.

In some embodiment, each of the fixed portion 101 and the rotating portion 102 further comprises a photoelectric alarm configured to prompt abnormal taking and placing of the carton. In other embodiments, other device can be used to prompt abnormal taking and placing of the carton. The scope of the present disclosure is not intended to be limited in this respect.

In some embodiment, each of the fixed portion 101 and the rotating portion 102 further comprises sensors configured to detect the abnormal carton adsorption. In other embodiments, other device can be used to detect the abnormal carton adsorption. The scope of the present disclosure is not intended to be limited in this respect.

In the embodiment as shown in FIG. 2, the second driving component 109 is a cylinder. In other embodiments, the second driving component 109 can be other driving device. The scope of the present disclosure is not intended to be limited in this respect.

In some embodiment, the first frame 103, the second frame 104 and the third frame 105 are made of aluminum profile to reduce the weight. In other embodiments, the first frame 103, the second frame 104 and the third frame 105 can be made of other material. The scope of the present disclosure is not intended to be limited in this respect.

In some embodiment, the first plurality of suction components 106 and the second plurality of suction components 107 comprise suction cups connected to a vacuum generator arranged on the first frame 103. In other embodiments, the first plurality of suction components 106 and the second plurality of suction components 107 can be other suction device. The scope of the present disclosure is not intended to be limited in this respect.

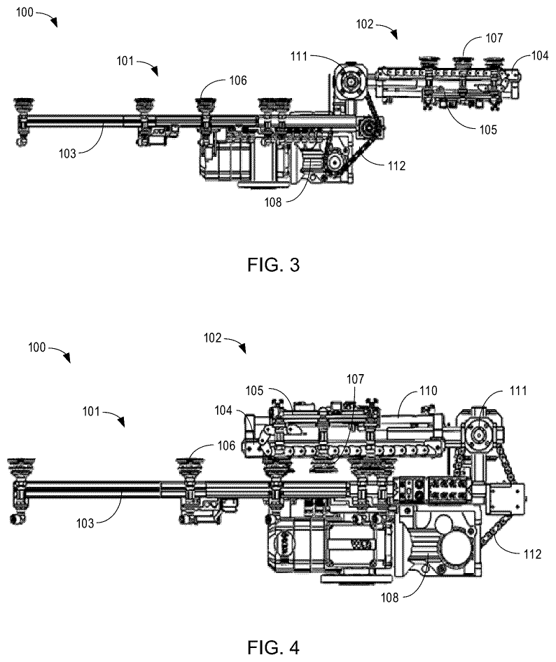

Hereinafter, the operation of the fixture in accordance with an embodiment of the present disclosure will be described in detail with reference to FIGS. 3-5. Refer to FIG. 3 first. FIG. 3 is a schematic view illustrating a fixture in a first position in accordance with an embodiment of the present disclosure.

As shown in FIG. 3, an angle between the rotating portion 102 and the fixed portion 101 is 180 degree. At this position, the first plurality of suction components 106 do not work, and the carton can be placed on the first plurality of suction components 106.

FIG. 4 is a schematic view illustrating a fixture in a second position in accordance with an embodiment of the present disclosure. As shown in FIG. 4, the rotating portion 102 is driven by first driving component 108 to a position where the angle between the rotating portion 102 and the fixed portion 101 is 0 degree. During the rotating of the rotating portion 102, the third frame 105 is fixed to the second frame 104 by the second driving component 109, so that the positions of the second plurality of suction components 107 can be controlled.

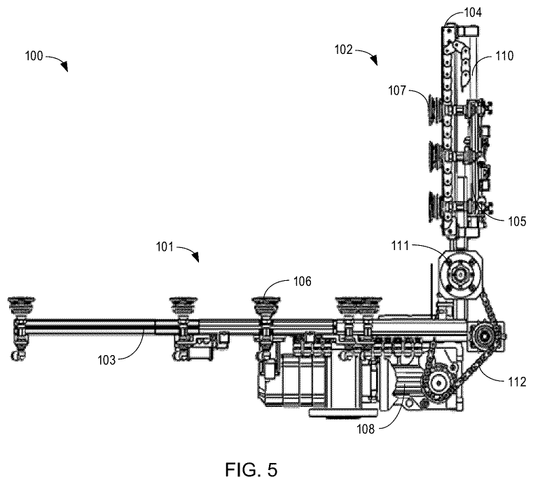

FIG. 5 is a schematic view illustrating a fixture in a third position in accordance with an embodiment of the present disclosure. As shown in FIG. 5, after the first plurality of suction components 106 and the second plurality of suction components 107 contact the carton at predetermined positions, the first plurality of suction components 106 and the second plurality of suction components 107 work, and two opposite sides of the carton are fixed to the first plurality of suction components 106 and the second plurality of suction components 107 respectively.

At this time, the rotating portion 102 is driven by first driving component 108 to a position where the angle between the rotating portion 102 and the fixed portion 101 is 90 degree, and the carton is unpacked. During the rotating of the rotating portion 102, the third frame 105 is not fixed to the second frame 104 by the second driving component 109, so that the rotation center of the rotating portion 102 can be adjusted automatically.

After the carton is unpacked, the industrial robot can operate the fixture to sheathe the carton to the product.

With above structures, large cartons can be accurate unpacked without manual work, thereby increasing the production efficiency and reduce the packing cost.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A fixture for unpacking a carton, comprising:
a fixed portion; and
a rotating portion,
wherein the fixed portion comprises:
a first frame;
a first plurality of suction components arranged on the first frame and capable of sucking a first part of the carton; and
a first driving component arranged on the first frame; and
wherein the rotating portion comprises:
a second frame connected to the first frame and capable of rotating or being fixed relative to the first frame under the driving of the first driving component;
a third frame arranged on the second frame and capable of moving relative to the second frame;
a second plurality of suction components arranged on the third frame and capable of sucking a second part of the carton; and
a second driving component connected to the second frame and the third frame and configured to fix the third frame to the second frame before the second plurality of suction components suck the carton, and not fix the third frame to the second frame after the second plurality of suction components suck the carton.

2. The fixture according to claim 1, wherein the third frame is arranged on the second frame through linear guide rails arranged on the second frame.

3. The fixture according to claim 1, wherein the first driving component comprises a servo motor, and the second frame comprises a sprocket connected to the servo motor through a chain.

4. The fixture according to claim 1, wherein the fixed portion further comprises a flange made of square steel and configured to connect the fixed portion to an industrial robot.

5. The fixture according to claim 1, wherein each of the fixed portion and the rotating portion further comprises a negative pressure gauge configured to check whether the carton is in place.

6. The fixture according to claim 1, wherein each of the fixed portion and the rotating portion further comprises a photoelectric alarm configured to prompt abnormal taking and placing of the carton.

7. The fixture according to claim 1, wherein each of the fixed portion and the rotating portion further comprises sensors configured to detect abnormal carton adsorption.

8. The fixture according to claim 1, wherein the second driving component comprises a cylinder.

9. The fixture according to claim 1, wherein the first frame, the second frame and the third frame are made of aluminum profile.

10. The fixture according to claim 1, wherein the first plurality of suction components and the second plurality of suction components comprise suction cups connected to a vacuum generator arranged on the first frame.
